(19) United States
(12) Patent Application Publication
(10) Pub. No.: US 2014/0201023 A1
(43) Pub. Date: Jul. 17, 2014

(54) System and Method for Virtual Fitting and Consumer Interaction

(71) Applicant: Xiaofan Tang, Fremont, CA (US)

(72) Inventor: Xiaofan Tang, Fremont, CA (US)

(21) Appl. No.: 14/153,000

(22) Filed: Jan. 11, 2014

Related U.S. Application Data
(60) Provisional application No. 61/751,255, filed on Jan. 11, 2013.
(60) Provisional application No. 61/800,528, filed on Mar. 15, 2013.

(51) Int. Cl. G06Q 30/06

(52) U.S. Cl. CPC G06Q 30/0643; G06Q 30/0621; G06Q 30/0633
USPC 705/26.5; 705/27.2; 705/26.8

(57) ABSTRACT

In a multimedia device, a method, apparatus, and system for presenting product information to user, provide the means and methods for user to virtually try on the products with user specific image/photo through user interaction, graphical image processing and generation, loading and switching images to generate a continuous virtual fitting experience. Collect and manage user input data and facilitate interaction between consumer and vendor.

This application is a continuation-in-part of Application No. 61/751,255, filed 2013 Jan. 11, and also a continuation-in-part of Application No. 61/800,528, filed 2013 Mar. 15.

### BACKGROUND OF THE INVENTION

1. Field of the Invention

This invention relates generally to a system that supports user interaction, data processing and computation, image processing and generation, that can be used on touch screen mobile phone/tablet/TV/computer application system. More particularly, the invention relates to a system and method for user's virtual fitting needs and interaction between consumer and vendor.

2. Description of Prior Art

When a consumer shops for apparels and accessories, he/she often needs to try on the product to see whether the product fits his/her style and taste. The process is that a consumer goes to a fitting room/area where a mirror is supplied, wears the apparel and/or accessories, looks into the mirror, reviews the reflection from the mirror, and makes the decision whether the product fits or not. When the consumer decides that the product fits, the consumer may proceed to purchase the item.

This is an inefficient process, because:

The consumer needs to pick out the apparels from the shelf, and physically try on each one of them to generate the visual result in the mirror.

Consumer may lose the interest of further fitting, after trying on a few items.

Consumer are not able to view most apparels in the store because of the large amount of the inventory prevents them from obtaining and trying on each one of them.

Consumer may miss the right apparel to purchase due to the large amount of the inventory.

If an apparel is not in stock, consumer cannot try it on. The vendor misses a selling opportunity.

Consumer can't try on apparel during online shopping, and will return apparel that does not fit after receiving it in mail.

Returned items increase operational cost of vendors in product shipping, handling, packaging, storage and etc.

Fitting causes wear and tear of the apparels.

Apparels less than brand new condition are harder to sell, may need to sell at a reduce price.

Apparels that have severe wear and tear are wasted, causing an increase in the operational cost for the vendors.

I have invented a system that provides the means and methods for consumers to virtually fit the products through graphical image processing and generation.

When a consumer wears an apparel and views his/her reflection from the mirror, what he/she sees is a combination of reflections generated by his/her own body as well the one generated by the apparel, which are fitted on or in other words positioned on his/her body. By viewing this combination of images, the consumer can visualize how the apparel fits, whether it is suitable to his/her style and taste, and make the purchase decision.

My invention creates a virtual fitting system that loads, processes and manages an image and data repository of a plurality of products, apparels, accessories and etc. During the virtual fitting process, it captures an image of the consumer, processes the image, and creates the graphical visual result of the consumer wearing the apparels. By processing the images of the apparels and of the consumer, through image cropping, positioning, scaling, rotating, stretching, zooming, compressing, removing and/or replacing background, changing color and/or transparency and etc, the virtual fitting system generates the visual result of the consumer wearing the apparels. Consumer can then review the graphic image result and visualize he/her wearing the apparels, and decide whether the apparel suites to his/her style and taste, and make the purchase decision.

Further more, through the virtual fitting system, the consumer can iterate through a polarity of similar products. By automatically loading, processing, generating and switching the displays of images, the virtual fitting system creates a continuously virtual fitting experience for the consumer.

Further more, through the virtual fitting system, the consumer can fit multiple apparels and accessories at the same time, and position them at different places on the body. Consumer can also input customization request, redesign the apparel, leave reviews and feedbacks, order and/or preorder the apparels, as well as conduct other consumer interaction activities using the graphical user interface component of the virtual fitting system.

Further more, the virtual fitting system loads and manages catalogs of inventory images and data from different sources, including but not limited to different vendors, manufactures, retail stores, brands, distribution channels and etc. The virtual fitting system manages these catalogs, loads and displays the catalogs that suites to the consumer's criteria based on consumer's preferences, location and etc,

Further more, the virtual fitting system are used to generate visualization result for fitting other types of products to the people, object(s) and/or environment(s) selected by the consumer.

For example, a consumer plans to purchase furniture from a retail store. The consumer may take a picture at home of the space and surrounding area where the furniture will be placed. The consumer brings this picture to the furniture store, loads the picture into the virtual fitting system of the furniture store, and marks the placeholder for the area where the furniture will be placed. Consumer also selects different pieces of furniture from the inventory list. The virtual fitting system then process the images and generates the visual result of the furniture being placed inside the consumer's home, the consumer reviews this virtual fitting result and makes the purchase decision.

Further more, the virtual fitting system are used to generate visualization result for fitting different types of products to the specified objects and/or environment selected by the consumer, each located at a different position in the generated image.

For example, a consumer plans to redecorate his/her living room. Using the virtual fitting system, the consumer takes a photo of his/her living room, loads the list of images of the furniture onto the graphic display of the system. Consumer selects different pieces of furniture from the inventory list, and position them into different areas on top of the photo of his/her living room, generating the visual result of a virtual redecoration of his/her living room with the images of the furniture, using the virtual fitting system that runs on his/her tablet.

Further more, the virtual fitting system is used to generate visualization result for fitting an image, a sign, a fixture and/or etc to a specified object selected by the consumer.

For example, when a consumer wants to paint an advertisement sign on a car. Using the virtual fitting system, the consumer takes a photo of the car, and marks a placeholder for the area where the sign can be posted. The consumer then select the image of the sign, and use the virtual fitting system to generate the visual result of the car having the sign painted on top of it.

As another example, a consumer wants to do some remodeling work for the front of his/her house. The consumer takes a picture of the front of the house, marks the placeholders for the areas where he/she want to change using the virtual fitting system. The consumer then pick out the images for the remodeling components that he/she want to put in, add them into the inventory list of virtual fitting system, and configure them as needed. During the virtual fitting process, consumer select the components from the inventory list, and the virtual fitting system will process the images and position the remodeling components on top of the house image. The consumer can then visualize how the house will look like after the remodeling work is completed, without really going through the lengthy remodeling process.

### SUMMARY OF THE INVENTION

In a multimedia device, a method, apparatus, and system for presenting product data and images to user, provide the means and methods for user to virtually try on the products with user specific images/photos through graphical image processing and generation, and user interaction. Collect and manage user input data and facilitate interaction between consumer and vendor.

The system can be used to assist user to virtually try on apparels and/or personal items including but not limited to clothing, accessories, purse, belt, hat, necklace, shoes, watch, jewelry, and etc. An apparel can be positioned graphically as desired with the image of the user, thus generates a virtual fitting visual effect. By processing the images of the apparels and of the user, through image cropping, positioning, scaling, rotating, stretching, zooming, compressing, removing and/or replacing background, changing color and/or transparency and etc, the virtual fitting system generates the visual result of the user wearing the apparels.

The virtual fitting system is also used to generate visual result for fitting other types of products to object/environment selected by the user, through graphical image processing and generation. For example, a product such as a door, can be positioned graphically as desired with the image of the user's house, and generates a visual effect of virtual fitting the door to the house.

According to still another aspect, the virtual fitting system can display and/or virtual a list of products in an efficient manner.

According to still another aspect, the virtual fitting system can iterate through a plurality of images and perform automatic image loading, processing, generation and displaying, rending a continuous virtual fitting experience to the user.

According to still another aspect, the virtual fitting system can manage a plurality of images and perform automatic image loading, editing, repositioning, processing, generation and displaying, rending an animated virtual fitting experience to the user.

In addition, it will assist user to input their reviews, feedbacks, customization preference and etc into the virtual fitting system. User can select the product through the system, customize and redesign the product based on user's style and preference, place in the orders and/or preorder products when they are not available in the inventory. These data entered by the user is collected by the system, processed and send to the corresponding parties.

According to still another aspect, the virtual fitting system can collect and accumulate user input data, manage this data by data consolidation, processing, filtering, formatting and/or etc, and render a summarized representation of the data using charts, tables, diagrams, graphical images, reports and/or etc. This summarized representation of the data can be viewed by user through the reporting module of the virtual fitting system. This summarized representation of the data can also be saved in digital format such as a file, database and etc, and transferred to corresponding parties through an automatic or manual process, through wiring or wireless network and etc. This summarized representation of the data can also be printed out through printers for representation, as well as presented through other representation media for review and display.

The user of the virtual fitting system can be a person and/or an organization with different roles including but not limited to a consumer, vendor, retailer, distributor, storeowner, designer, manufacture and etc.

According to still another aspect, the virtual fitting system can facilitate consumers to place in user feedbacks and customized orders for products. Vendors can present products that are available and/or not yet available on the market, as well as templates or prototypes of products to consumers through the virtual fitting system. Consumer can review and/or preview these products, leave reviews, feedbacks, and ratings for the products. Consumers can also customize and redesign the products based on his/her style and preference. The virtual fitting system collects the user input data from consumers, manage and process this data by data consolidation, processing, filtering, formatting and/or etc, and transfer the data to vendor. Consumers can also place in orders, preorder, patch order, bulk order, combine orders for products, with or without customizations through the virtual fitting system.

The virtual fitting system includes camera(s), touch screen graphic display(s), processor(s) and memory(s). The system may also include units such as media storage, battery, sensors, input and output units, if not combined as part of another unit of the virtual fitting system, The system may also include units for wiring and wireless communication. The system may also include an internal and/or external display unit such as a TV, projector and/or etc.

The camera captures the images of the user, as well as images of the product. The processor generates a plurality of matrices, computes the data and processes the images. The data storage unit stores the data and images, and the touch screen graphic display unit presents the graphical images and data to user and handles user interaction. The external display unit provides additional graphical displays to the user, potentially, on a large display surface.

According to one aspect, the virtual fitting system can be a portable media device also function as a solid-state drive for data storage. The form factor of the virtual fitting system can be hand-held and portable, or it can be a graphical display device with computation capability such as a smart phone, tablet and/or touch screen TV. The virtual fitting system can also include a peripheral bus connector, a rechargeable battery, and one or more input and output devices. According to another aspect, the virtual fitting system has the capability to store media in persistent memory. Thereafter, when the virtual fitting system is again powered up, the stored media and data can be retrieved and utilized.

According to still another aspect, the virtual fitting system can form, display and/or traverse the data and image assets in an efficient manner, through a manual, semi-automatic and/or automatic process.

### BRIEF DESCRIPTION OF THE DRAWINGS

For a more succinct understanding of the nature and objects of the present invention, reference should be directed to the following detailed description taken in connection with the accompanying drawings in which:

FIG. 1 is a diagram for a preferred embodiment of the implementation of the virtual fitting system.

FIG. 2 is a block diagram of a virtual fitting system according to one embodiment of the invention.

FIG. 3A is a flowchart that shows the sequence of the processes when a user loads and configures images of products to create an inventory list, and stores the data to prepare for the virtual fitting process, according to one embodiment of the invention.

FIG. 3B is a flowchart that shows the virtual fitting process according to one embodiment of the invention.

FIG. 4A shows an illustration of preparing for the virtual fitting by drawing a placeholder on top of the image of an apparel on a touch screen display device.

FIG. 4B shows an illustration of preparing for the virtual fitting by drawing a placeholder around the face area on a user's photo on a touch screen display device.

FIG. 4C shows an illustration of a virtual fitting result. The image of the apparel is positioned on top of the image of the user, with the placeholder matching to each other's placeholder, generates a visual effect of the consumer wearing the apparel.

FIG. 4D shows an illustration of a customization request entered by a user on top of a virtual fit graphic result generated by the virtual fitting system, on a touch screen display. The user requests the vendor to provide a customized version of the apparel with shorter sleeves.

FIG. 4E shows an illustration of the virtual fitting system process and configure the image of the apparel, based on the body type of the user, and renders a visual effect of the apparel being suited to a user with leaner and/or larger body type.

FIG. 5 shows an illustration of the process of the virtual fitting system scan and measures dimensions of a user's body.

FIG. 6 shows an illustration of a user makes customization to an apparel by changing the color of the apparel.

FIG. 7 shows an illustration of the process of virtual fitting the user's hand with a watch.

FIG. 8 shows an illustration of the process of virtual fitting the image of the back of a bus with an advertisement sign with a swimming logo.

FIG. 9 shows an illustration of the process of virtual fitting the front of a house with a new canopy and door.

FIG. 10 shows an illustration of a user customizes the design of a car by marking the areas that need to be changed on a touch screen display.

FIG. 11A shows an illustration of a user measures the distance between two walls in his/her room.

FIG. 11B is another diagram of an exemplary embodiment of the implementation of the virtual fitting system, where the user marks a line for the distance that he/she measured, and enters the measured length on the touch screen display.

FIG. 11C is another diagram of said exemplary embodiment of the implementation of the virtual fitting system, where the user is using the virtual fitting system to virtual fit his/her room with sofas, using his/her finger to drag and drop the sofa to a different location on top of the image of his/her room on a touch screen display.

FIG. 12 shows an illustration of the virtual fitting system collects users' feedbacks on different tail wing designs for a new car model, and generates reporting charts based on the collected data.

### DETAILED DESCRIPTION OF THE INVENTION

While the present invention may be embodied in many different forms, designs or configurations, for the purpose of promoting an understanding of the principles of the invention, reference will be made to the embodiments illustrated in the drawings and specific language will be used to describe the same. It will nevertheless be understood that no limitation of the scope of the invention is thereby intended. Any alterations and further implementations of the principles of the invention as described herein are contemplated as would normally occur to one skilled in the art to which the invention relates.

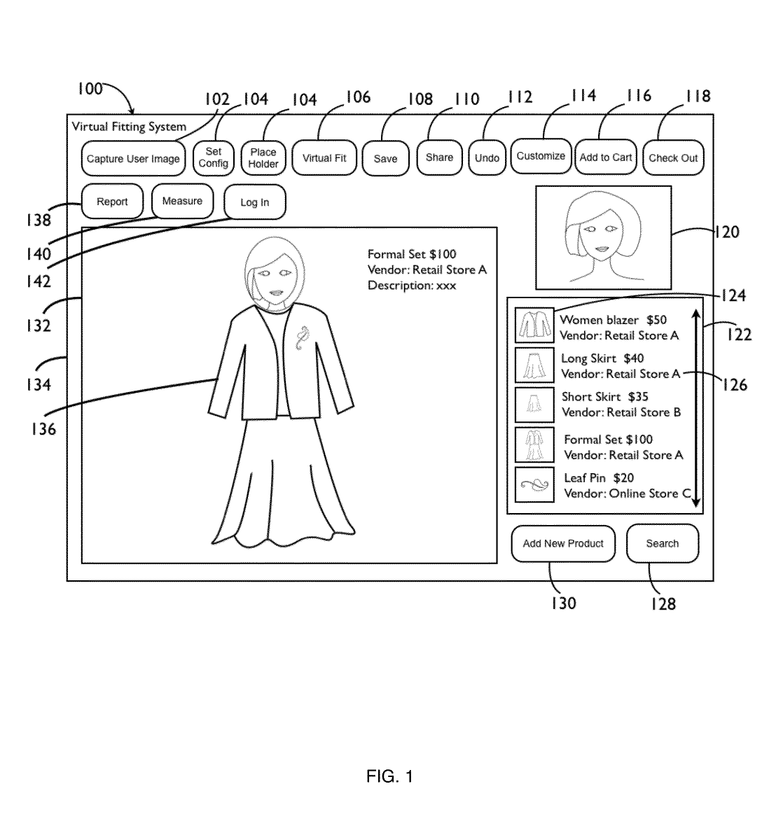

With reference to FIG. 1, an embodiment for implementation of a virtual fitting system, such as virtual fitting system 100. For this implementation of the virtual fitting system 100, the user interaction is handled through the touch screen display 134. The inventory list of the apparels 122 are loaded into the memory 208 when the virtual fitting system 100 was started. By clicking the add new product button 130, user can load new product from the media storage 210, or user can capture new image of a product through camera 202, and add it into the inventory list 122. Consumer can search for products that may meet his/her criteria by click the search button 128 and enter keywords to conduct a search. The products that result from this search will be displayed in the inventory list 122. A snapshot of the product, as well as product description, vendor name, pricing and other information related to the product are shown for the product item 126 on the inventory list 122.

When a user starts the virtual fitting process, he/she click the capture user image button 102, which enables the camera 202, and take a picture of the user 310. The image is then display on the user image area 120. The user select the user image 120 to display it on the user input area 132, review and mark the placeholder(s) 306 on his/her image 310, to prepare for the virtual fitting process. User clicks the set configuration button 104 to save the configurations and store the configuration data to the system memory 208. By clicking the virtual fit button 106, user starts the virtual fitting process. User selects product(s) from the inventory list 122 to perform the virtual fitting. User can virtual fit a list of products in an efficient manner, by iterating through the inventory list 122. The visual graphical result 136 generated by combining the user image with the image of the product is displayed in user input area 132. User may save the virtual fitting result 136 to the system by clicking the save button 108. By clicking the share button 110, user may select and share the image and data with other people or system, through email, messaging, social sharing channels, Wi-Fi, bluetooth and other sharing tools and methods. User can undo the fitting result and/or placeholder configuration by clicking the undo button 112. User can customize the product(s) by clicking the customize button 114, and input customization details through the user input area 132 on the touch screen display 134. After reviewing the virtual fitting result 136, user can add products to his/her shopping cart by clicking the add to cart button 116, and proceed to check out to complete the purchase by clicking the checkout button 118. User may click the report button 138 to view and manage reports generated from the data collected by the virtual fitting system. User may click the measure button 140 to measure and detect the size, length, dimension, shape and etc of an object shown in the image. User may click the log in button 142 to register or log into the virtual fitting system.

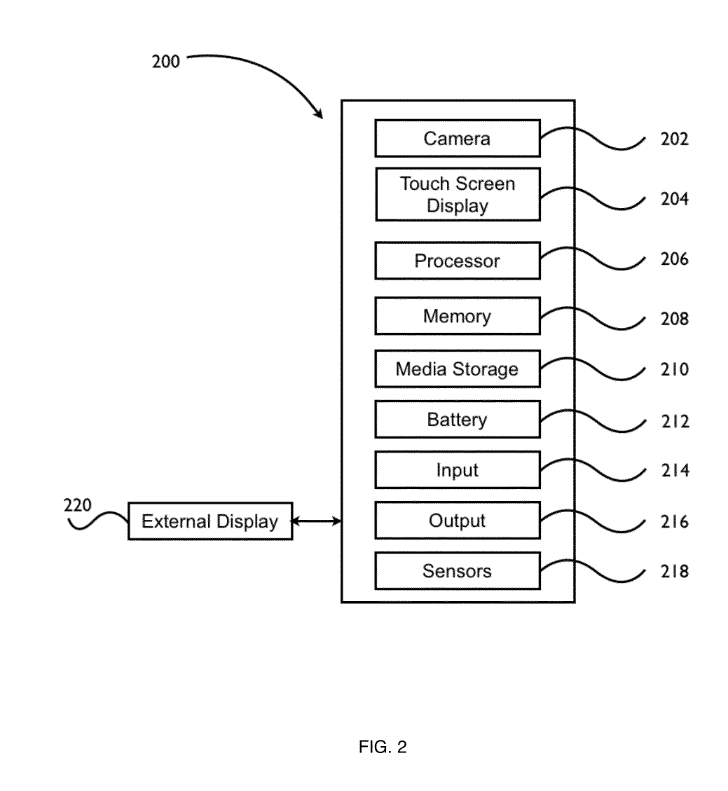

With reference to FIG. 2, an embodiment of a virtual fitting environment for implementing the embodiments described herein includes a virtual fitting system, such as virtual fitting system 200. Any and all components of the virtual fitting system may execute as or on a touch screen mobile device such as a phone or tablet, a touch screen TV with computation capability, a computer system, and/or other possible multi-media devices with computation capability. As such, a basic virtual fitting system applicable to all these environments is described hereinafter.

In its most basic configuration, virtual fitting system 200 comprises at least one processing unit or processor 206 and system memory 208, a camera 202, a touch screen display 204. In embodiments, data and images are loaded into memory 208 and executed by the processing unit 206 from system memory 208. Depending on the exact configuration and type of system 200, memory 208 may be volatile (such as RAM), non-volatile (such as ROM, flash memory, etc.), or some combination of the two.

Additionally, virtual fitting system 200 may also have other components. For example, virtual fitting system 200 includes additional media storage 210, such as removable and/or non-removable media storage, including, but not limited to, SD memory card, magnetic or optical disks or tape. Virtual fitting system 200 may have battery 212 to provide power when not connected to an external power source.

Virtual fitting system 200 may have input component 214 such as graphic drawing pad, mouse, keyboard and etc. The display may be embedded with touch sensors, thus function as a touch screen display 204. The virtual fitting system 200 may have output component 216, which handles the displays and transfer of both image and data outputs from the virtual fitting system to other devices and/or systems. Virtual fitting system 200 may have sensor component(s) 218, such as touch sensor, light sensor, GPS sensor, near field communication sensor and/or etc to handle the sensing, receiving and transferring of data.

Virtual fitting system 200 can use an external display 220 to provide better visualization result, such external display 220 can be a TV, a projector device and/or etc. The external display 220 may be connected with the virtual fitting system 200 through wiring or wireless connections including but not limited to Wi-Fi, bluetooth connection and/or etc.

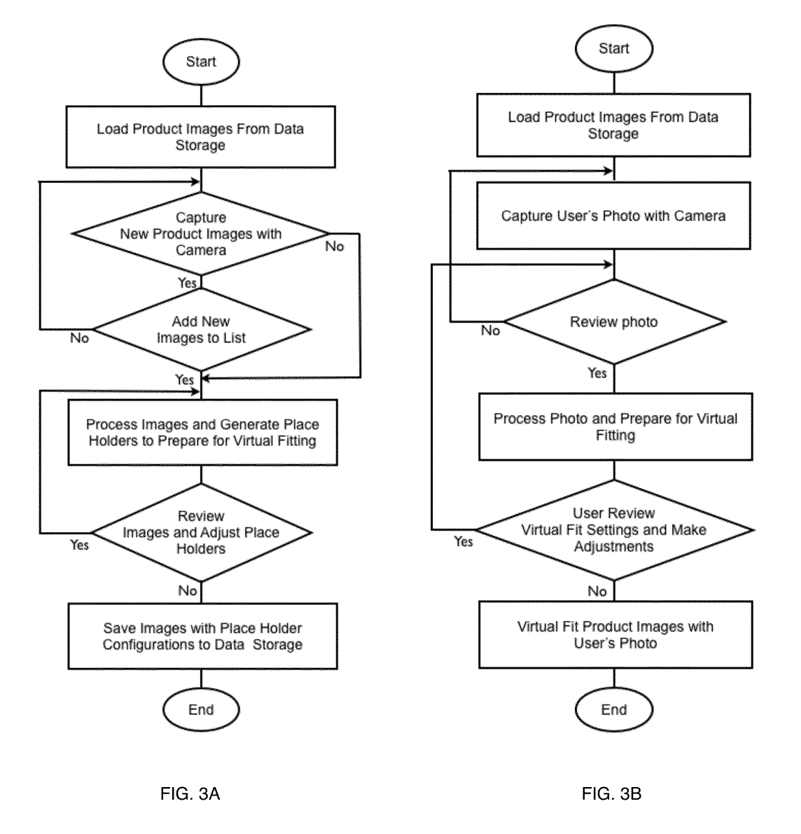

With reference to FIG. 3A, a user creates an image repository for the products to prepare for the virtual fitting process. User starts the virtual fitting system, loads images of the products from memory 208 or media storage 210 that is located on the system 200. User may use camera 202 to capture new images of the products and add them to the list of inventory 122. User may load and input the corresponding product details 126 including but not limited to product description, vendor name, pricing and other information related to the product. User may mark the placeholders for the product images, review and adjust such placeholders until they are properly placed for the virtual fitting purpose. User may save the images as well as the configuration data of the placeholders to system memory 208 and/or media storage 210. The configured product images are shown in the inventory list 122 and ready for the virtual fitting process.

With reference to FIG. 3B, a user starts the virtual fitting process, the user loads the product images from the system memory 208 and/or media storage 210, the product images that are available for virtual fitting are shown in the inventory list 122. User can take a photo of himself/herself, or an object that will be used for virtual fitting with the camera 202. User reviews the processed photos and adjusts settings until they are properly placed for the virtual fitting purpose. User may save the configuration settings by clicking the set configuration button 104. Then the user may select the products from the inventory list 122 and starts the virtual fitting process. The virtual fitting system processes the images, and generates the virtual fitting result and displays it on the user input area 132 on the touch screen display 134. The user can review the visual result generated by the virtual fitting system 200 on the touch screen display 204 and/or external display unit 220. User can virtual fit a list of products in an efficient manner, by iterating through the inventory list 122.

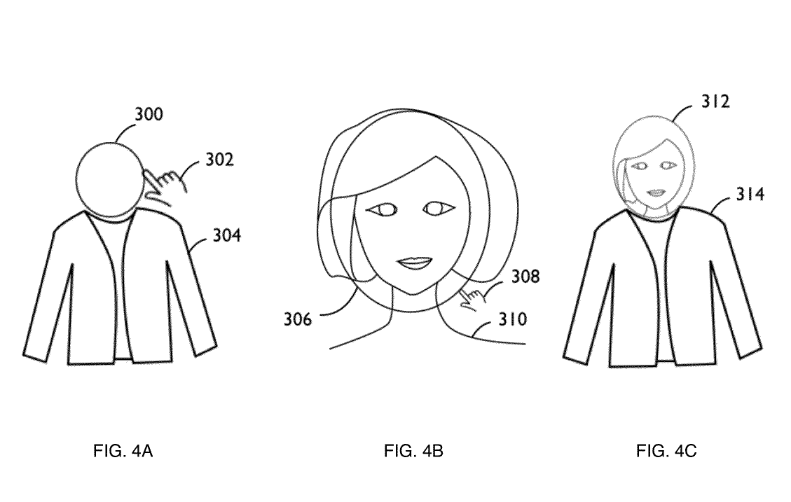

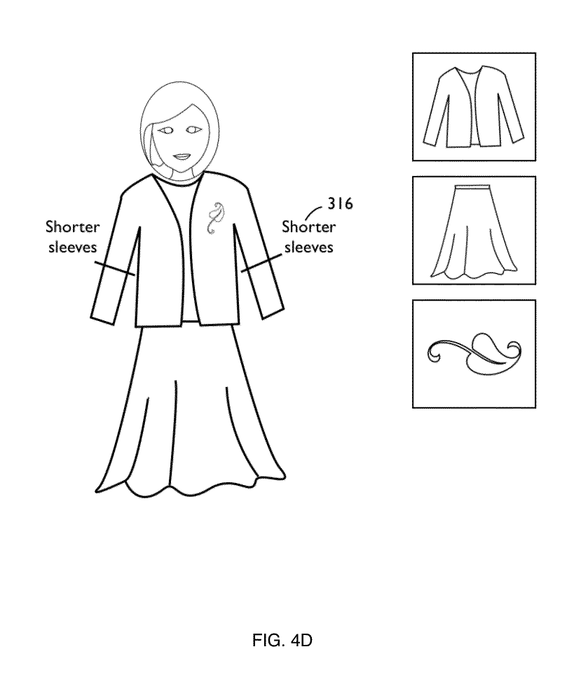

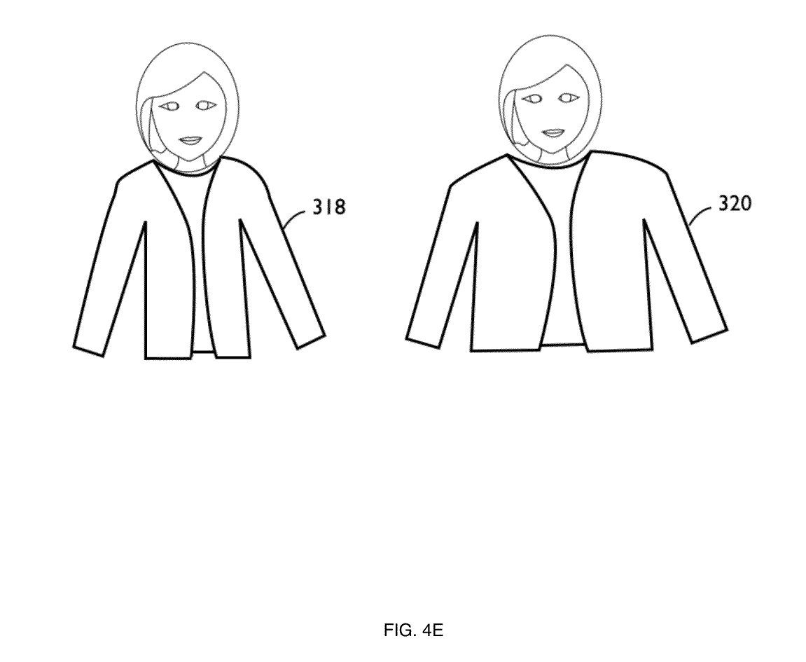

With reference to FIG. 4A, a user select an image of a product 304 to from the inventory list 122, the image is display on the user input area 132. The user uses a finger 302 or a drawing media such as a tablet stylus pen and etc, and draws a placeholder 300 on the user input area 132. When the user clicked the set configuration button 104, the configuration settings are saved in system memory 208. When user clicked the save button 108, the processed image as well as the configuration data of the placeholders are stored into system memory 208 and/or media storage 210.

With reference to FIG. 4B, a user select an image of a user 120, the image is display on the user input area 132. The user uses a finger 308 or a drawing media such as a tablet stylus pen and etc, and draws a placeholder 306 on the user input area 132. When the user clicked the set configuration button 104, the configuration settings are saved in system memory 208. When user clicked the save button 108, the processed image as well as the configuration data of the placeholders are stored into system memory 208 and/or media storage 210.

With reference to FIG. 4C, a user performed the virtual fitting process by clicking on the virtual fit button 106. The virtual fitting system 100 generates the virtual fitting result and displays it on the user input area 132. The virtual fitting result is a graphical display with the product and/or the user's images being edited and processed, and positioned as appropriate with each other, and creates a visual effect of the user/object virtually fitted with the product. In the example shown in FIG. 4C, it is a user wearing an apparel.

With reference to FIG. 4D, a user reviews the virtual fitting result, and leaves customization feedbacks on the user input area 132, requests a customized version of the apparel with shorter sleeves 316. Based on the configuration of the system, user may share 110 the feedback with other parties, send request/feedbacks to the vendor or designer, add/or this customized apparel to her shopping cart 116, and proceed to the check out 118.

Further more, with reference to FIG. 4E, based on the body type of the user or shape of the object, the system can then stretch 320 or shrink 318 the product image or portions of the product image to match the body type of the user and/or shape of the object, and enhance the virtual fitting result. FIG. 4E shows an illustration of the system process and configure the image of the apparel, based on the body type of the user, renders a visual effect of the apparel being suited to a user with a leaner or larger body type.

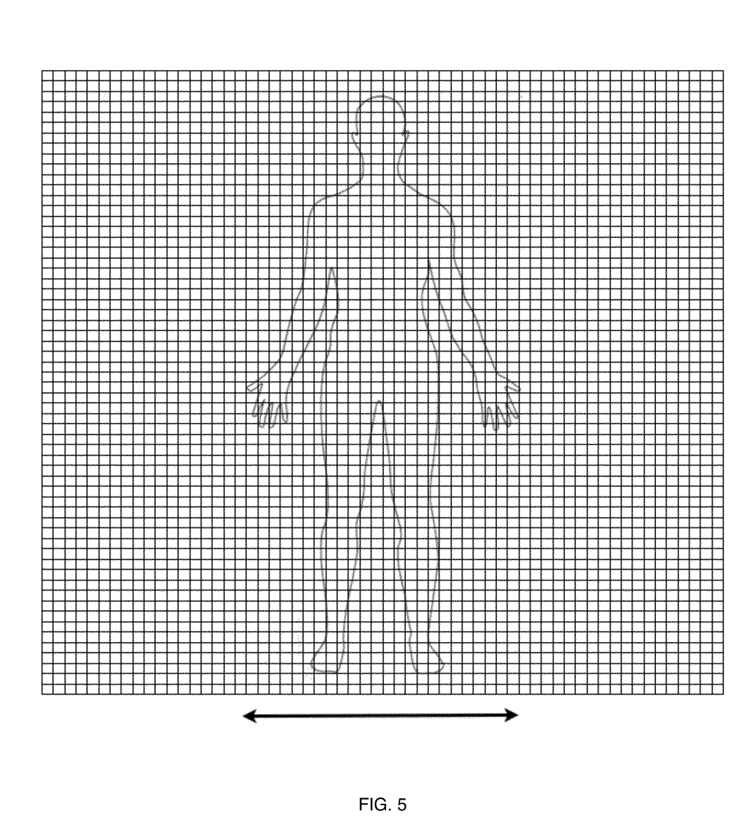

With reference to FIG. 5, by requesting user to enter information such as height, weight, dimension, length and other data, and by measuring and processing the image with metrics and other measures, the virtual fitting system 200 can calculate and detect the body type of the user, or the shape/dimension of the object.

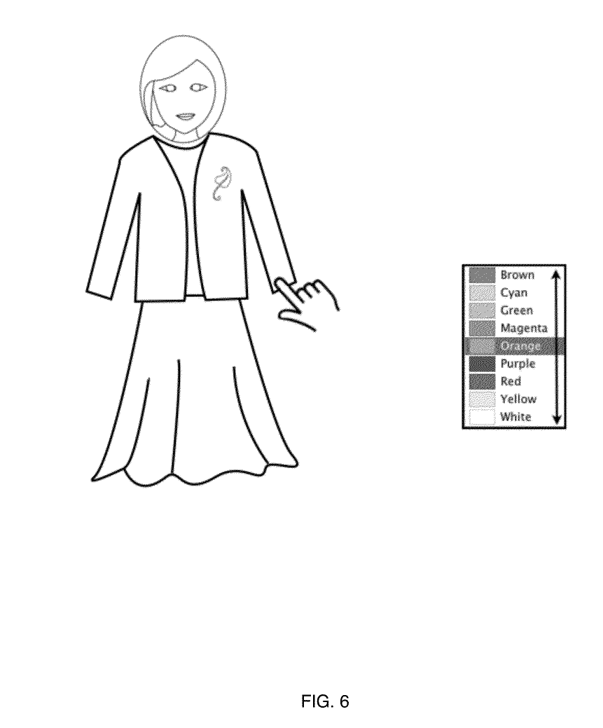

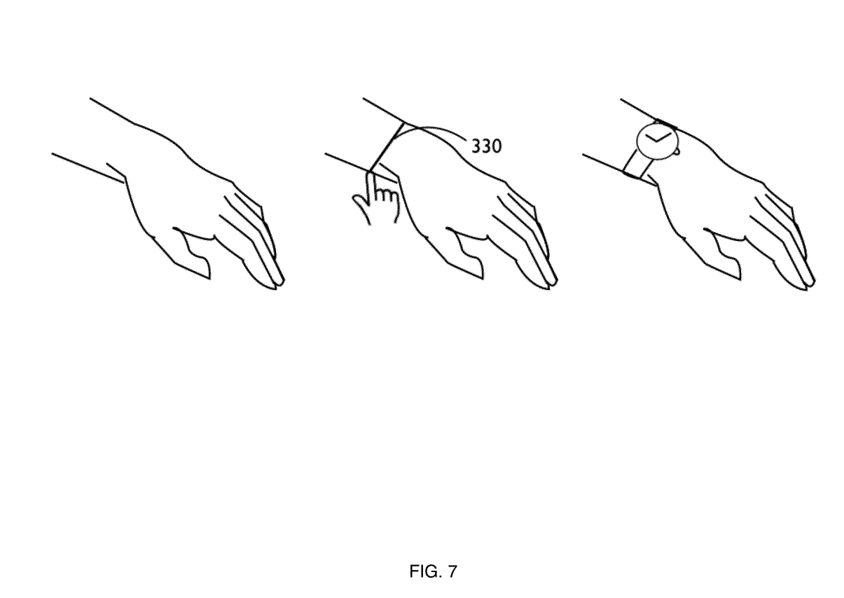

With reference to FIG. 6, using the virtual fitting system, user can customized 114 the product by changing its shape, size, color, dimension can etc. User can also customized the product by adding, removing, positions, editing components, elements, attachments, fixtures and etc to the product. FIG. 6 shows a user replaced the color of the apparel by choosing a different color from the color palette provided by the virtual fitting system.

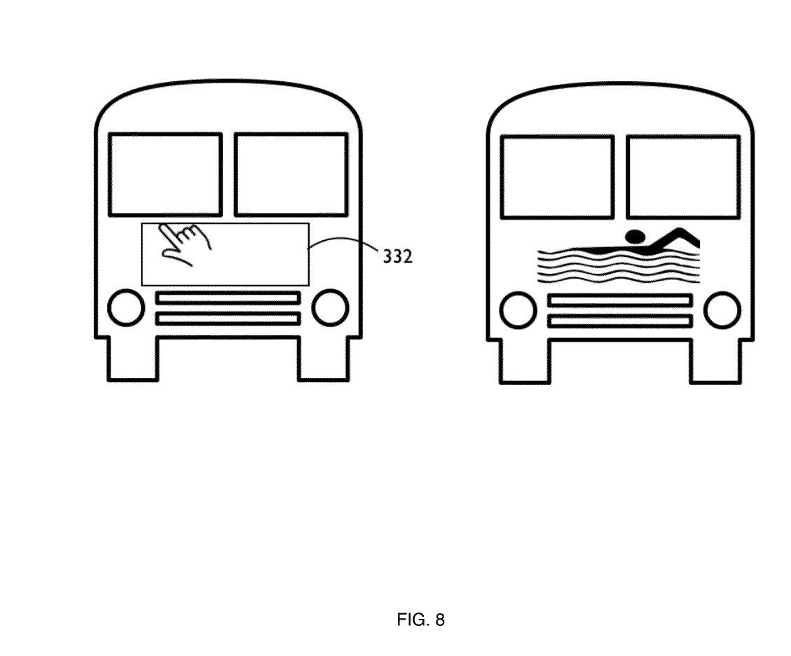

FIG. 7 shows an illustration of the process of virtual fitting the user's hand with a watch. User takes a photo of his/her hand, select the photo for editing, mark the placeholder 330 on the user input area 132, and virtual fit 106 it with a watch that he/she selected from the inventory list 122.

FIG. 8 shows an illustration of the process of virtual fitting the image of the back of a bus with an advertisement image of swimming. User takes a photo of the back of a bus, select the photo for editing, mark the placeholder 332 on the user input area 132, and virtual fit 106 it with a advertisement design graphic that he/she selects from the inventory list 122.

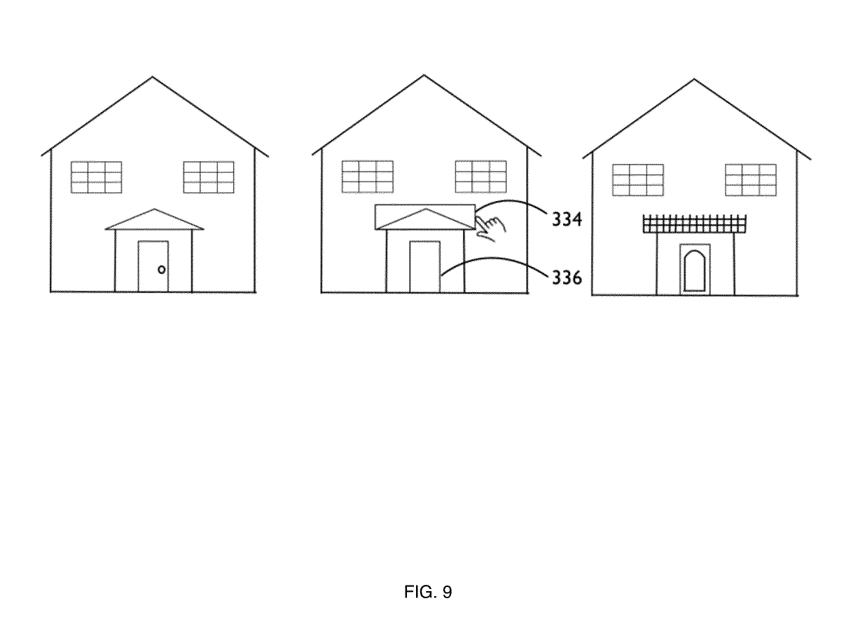

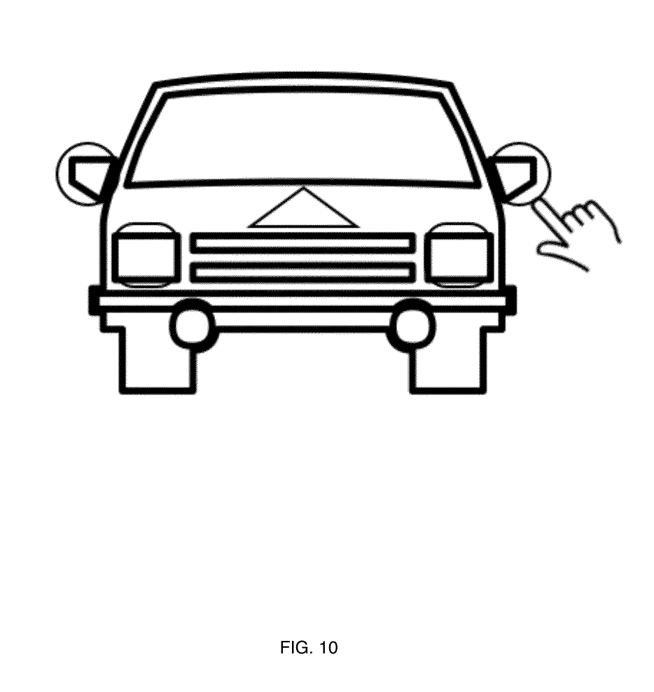

FIG. 9 shows an illustration of the process of virtual fitting the front of a house with a new canopy and door. User takes a photo of the front of a house, select the photo for editing, mark the placeholders 334 and 336 on the user input area 132, and virtual fit 106 it with a canopy and a door that he/she selected from the inventory list 122.

FIG. 10 shows an illustration of a user customizes the design of a car by marking the areas that need to be changed on a touch screen display.

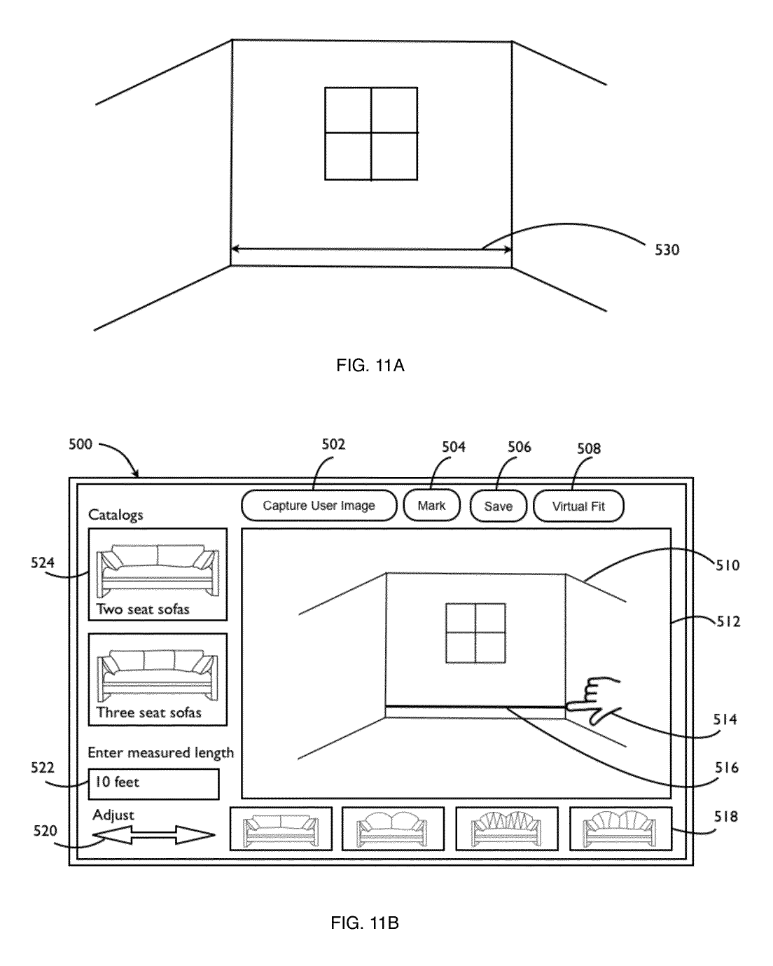

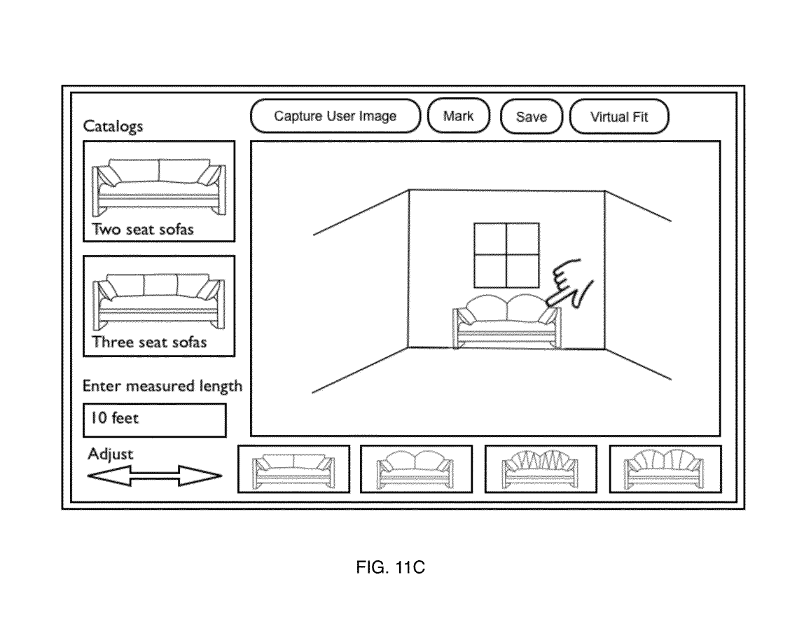

FIG. 11A shows an illustration of a user measures the distance 530 between two walls in his/her room, using a measuring tape.

FIG. 11B is another diagram of an exemplary embodiment of the implementation of the virtual fitting system 500. The user clicks on the capture user image button 502 and takes a photo of his/her room using the device, the photo is displayed on the user image display area 512. He/she then clicks on the mark button 504, and draw a line 516 using his/her finger 514 on the touch screen display, tracing the distance 530 that he/she measured. He/she enters the measured length and unit 522 on the device, saves the settings by clicking on the save button 506, and clicks on the virtual fit button 508 to start virtual fitting products. User may virtual fit different products to his/her photo by clicking on the image icons 518 of the products. User may choose different product collections by selecting different catalogs 524, adjust the virtual fit settings using the adjust component 520.

FIG. 11C is another diagram of an exemplary embodiment of the implementation of the virtual fitting system, where the user is using the virtual fitting system to select sofa for his/her room, using his/her finger to drag and drop the image of a sofa to a different location on a photo of his/her room.

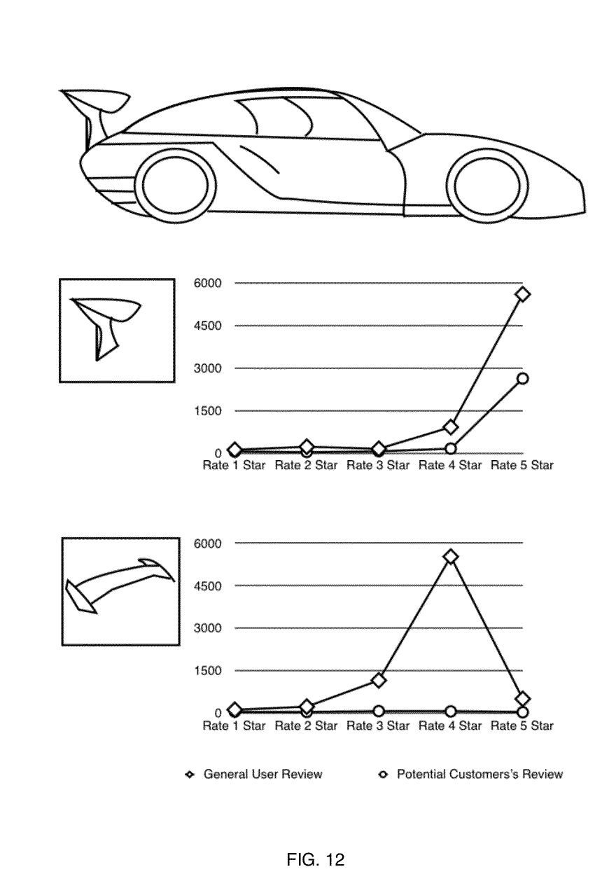

FIG. 12 shows a diagram with the illustration of the virtual fitting system collects users' reviews on different tail wing designs for a new car, compute the statistics of the data, and generates reporting charts. The first design receives positive feedbacks from both general users and potential customers, and has more five star ratings.

Further more, using the virtual fitting system 100, user may select a prototype product item from the inventory list 122, user may enter customized design inputs on the user input area 132, user may add the prototype product item to the shopping cart 116, order and/or preorder 118 the customized product. User may share 110 the customized design to other parties, user may send this customization request to the vendor or interact in other ways referring to the customized design. The virtual fitting system may collect customized design inputs from a plurality of users, process and consolidate the data, and generate reports from the data. The reports are sent to vendor and/or designer, and vendor and/or designer may use the information to refine and complete the product or the prototype of a product.

In this embodiment of usage, the virtual fitting system facilitates the vendor to enhance and refine a product or a prototype of a product, by collecting and consolidating user input from consumers and/or potential customers. Further more, a vendor can start the manufacture or production of a product after the prototype have been reviewed preferably by a quantified group of consumers, A vendor may start the manufacture or production of a product when a plurality of order/preorder has been place on the product and/or prototype of a product. A vendor may also allocate their resources by manufacturing or producing the product lines or variation of the products that are preferred by a large number of consumers. It is a thus encapsulated as virtual fitting the product with the market before production. Or in other words, testing a product with the market before manufacturing the product. This invention, in time, shall increase the efficiency in the chain of activities in production process, that includes but not limited to product design, supply, sourcing, manufacturing, producing, distribution, marketing, sales and consumption.

While this invention has been described in terms of a preferred embodiment, there are alterations, permutations, and equivalents that fall within the scope of this invention. It should also be noted that there are many alternative ways of implementing both the process and apparatus of the present invention. It is therefore intended that the invention be interpreted as including all such alterations, permutations, and equivalents as fall within the true spirit and scope of the present invention.

Although the invention is described herein with reference to the preferred embodiment, one skilled in the art will readily appreciate that other applications may be substituted for those set forth herein without departing from the spirit and scope of the present invention.

What is claimed is:

1. A system for virtual fitting products, comprising:
a. a component to display product image(s) and data to user;
b. means for user to iterate and/or browse through said product image(s) and data; and
c. means for user to interact with the system and enter user data; and
d. means for user to capture, load and/or select photo of himself/herself and/or his/her environment using the system; and
e. means to process the data and image(s), generate graphic image(s) with the virtual fitting visual result of said product(s) fit onto said user and/or said user's environment; and
f. means for said system to iterate and automatically process a plurality of product image(s), generate a plurality of graphic image(s) with virtual fitting visual results, rendering a continuous virtual fitting experience to the user.

2. A system for virtual fitting products in accordance with claim 1, where in said user can virtual fit a plurality of his/her photos to a plurality of product images at the same time.

3. A system for virtual fitting products in accordance with claim 1, further comprising claim initiating means for said user to purchase, order, preorder and/or combine orders of products through said system.

4. A system for virtual fitting products in accordance with claim 1, further comprising claim initiating means for said user to enter customization request, redesign said product(s), add, remove and/or replace component(s) and/or feature(s) of product(s) through said system.

5. A system for virtual fitting products in accordance with claim 1, further comprising claim initiating means for said user to enter review, comments and feedbacks for products, to communicate with providers, vendors, designers and/or other corresponding parties through said system.

6. A system for virtual fitting products in accordance with claim 1, further comprising claim initiating means for said user to virtual fit image(s) of object(s) and/or environment to images of another object(s) and/or environment captured, loaded and/or selected by said user.

7. A system for virtual fitting products in accordance with claim 1, further comprising claim initiating means for said system to generate reports for data received, processed and sent through said system.

8. A system for virtual fitting products in accordance with claim 1, further comprising claim initiating means for providers, vendors, designers and/or other corresponding parties to deliver, distribute, display and/or showcase product catalogs, data, images and/or promotional information to user(s).

9. A method for virtual fitting apparels, comprising:
a. user takes a picture of himself/herself, and load said photo onto the device;
b. user browse through the apparels on the device; and
c. user select an apparel from the list and virtual fit the image of said apparel to said his/her photo on said device; and
d. means for user to view a computer generated graphic image, with the visual effect of said user wearing the apparel, through image processing, editing, generation, and displaying on said device.

10. A method for virtual fitting apparels in accordance with claim 9, further comprising claim initiating means for user to virtual fitting apparels and/or products with images of people, objects and/or environment captured and/or selected by the user.

11. A method for virtual fitting apparels in accordance with claim 9, further comprising claim initiating means for a plurality of products to virtual fit with a plurality of images of people, objects and/or environment at the same time.

12. A method for virtual fitting objects, comprising:
a. user captures, loads and/or selects a photo and/or image of himself/herself, people, object and/or environment onto a graphic display system;
b. user marks one or a plurality of points, lines, shapes and/or areas on top of a background image displayed on said graphic display system; and
c. user adjust the location, angle, length, size and/or shape of said points, lines, shapes and/or areas on said graphic display system; and
d. means for said system to load and display one or a plurality of other image(s) on top of said background image; and
e. means for said system to adjust said other image(s), scale and/or position said other image(s) corresponding to said points, lines, shapes and/or areas marked and/or adjusted by said user; and
f. means for said system to remove and/or hide said points, lines, shapes and/or areas, generating the visual graphic image result of said other image(s) virtually fit onto said background image(s).

13. A method for virtual fitting objects in accordance with claim 12, further comprising claim initiating means for said system to automatically compute, adjust, scale and/or position a plurality other image(s) corresponding to the same said points, lines, shapes and/or areas, on top of said background image(s), creating a continuous virtual fitting experience for said user.

14. A method for virtual fitting objects in accordance with claim 12, where in said system automatically compute, adjust, scale and/or position said other image(s) corresponding to a recalculated and/or repositioned location, angle, dimension, size and/or shape of said points, lines, shapes and/or areas, creating an animated and/or continuous virtual fitting experience for said user.

15. A method for virtual fitting objects in accordance with claim 12, where in said points, lines, shapes and/or areas are entered, generated and/or controlled through positioning and adjusting an image and/or graphic component(s) with specific attributes including but not limited to mark(s), mask(s), transparent area, pixilated area, whitened area, blackout area, measurement(s), dimension(s), and etc.

16. A method for virtual fitting items based on measured dimensions, comprising:
a. user measures a distance between two points for the people, object and/or environment and he/she selects, using a measuring tool such as a measuring tape, ruler and etc,
b. user takes an picture of said people, object and/or environment, and load said photo onto a graphic display system; and
c. user marks a line on top of said photo on said graphic display, tracing the measured line between said two points; and
d. user entered the data and/or unit of for said measured distance on said graphic display system; and
e. means for said system to process and compute the length of the line marked and displayed on said graphic display system, corresponding to data entered by said user for said measured distance; and
f. means for said system to parse and process the dimension, width, length and/or size information of the product(s) using the data stored in the data storage of said system; and
g. means for said virtual fitting system to compute, adjust, resize and/or scale the image of the product(s), corresponding to the length of said marked line on said graphic display system, so that the size(s) of the product(s) shows up in proportion to said people, object and/or environment in said background image, corresponding to their real dimensions,
h. means for said system to remove and/or hide said line marked by the user, generating the visual graphic image result of said product(s) virtually fit to said people, object and/or environment, proportional to their real dimensions.

17. A method for virtual fitting items based on measured dimensions, further comprising claim initiating means for said system to automatically display, compute, adjust, scale and/or position a plurality of image(s) corresponding to the same said line(s) and/or dimension(s), on top of said background image(s), creating a continuous virtual fitting experience for said user, so that said product(s), people, object(s) and/or environment(s) shows up in proportion to their real dimensions in the virtual fitting result.

18. A method for virtual fitting items based on measured dimensions, where in said image of said product is displayed in the background, while said image(s) of said people, object and/or environment is displayed in the foreground.

19. A system for virtual fitting products with images of objects selected by the user, comprising:
a. a display;
b. a memory; and
c. a camera; and
d. a processor, operatively coupled to the display, the memory and the camera; and
e. an application stored in the memory and executable on the processor, for handling user interaction, computation, processing and managing the images and data, and generating the virtual fitting graphical results.

20. A system for virtual fitting products with images of objects selected by the user in accordance with claim 19, further comprising sensors such as touch sensors that are embedded in a touch screen display.

21. A system for virtual fitting products with images of objects selected by the user in accordance with claim 19, further comprising internal or external storage to store the data.

22. A system for virtual fitting products with images of objects selected by the user in accordance with claim 19, further comprising a network interface for connecting with other systems through a wireless or wiring network.

23. A system for virtual fitting products with images of objects selected by the user in accordance with claim 19, further comprising claim initiating means for said virtual fitting system to interact with and/or be part of a point of sale system.

24. A system for virtual fitting products with images of objects selected by the user in accordance with claim 19, further comprising claim initiating means for said system to be used inside and/or outside a retail store, on touch screen mobile phone/tablet/TV/computer application system and etc.
